(19) United States
(12) Patent Application Publication
(10) Pub. No.: US 2014/0186129 A1
(43) Pub. Date: Jul. 3, 2014

(54) HIGH SHEAR CUTTING TOOL

(71) Applicants: David Grover Freund, Hiram, GA (US); Martin Bradley Neagu, Edwardsburg, MI (US); Gregory Edmon Privette, Villa Rica, GA (US)

(72) Inventors: David Grover Freund, Hiram, GA (US); Martin Bradley Neagu, Edwardsburg, MI (US); Gregory Edmon Privette, Villa Rica, GA (US)

(21) Appl. No.: 14/133,008

(22) Filed: Dec. 18, 2013

Related U.S. Application Data
(60) Provisional application No. 61/748,664, filed on Jan. 3, 2013.

(51) Int. Cl. B23C 5/18

(52) U.S. Cl. CPC B23C 5/18
USPC 407/56; 409/131

(57) ABSTRACT

A high shear angle cutting tool and method of making is disclosed. A rotary cutting tool with a plurality of teeth can cause damage to a work piece during cutting. By orienting the cutting angle of the teeth relative to the rotational central axis to 50 degrees or greater, the tool creates a high compression cut which is cleaner and less damaging to the work piece.

### CROSS REFERENCE

This application claims priority of provisional application Ser. No. 61/748,664 filed Jan. 3, 2013 of the same title and is also hereby incorporated by reference in its entirety.

### BACKGROUND

The present invention relates to a high shear cutting tool and, more particularly, to a high shear cutting tool with a cutting angle greater than about 50 degrees.

Currently, cutting tools may be used to drill holes and cut shapes in different types of metals and woods. However, cutting tools may not always leave a clean cut and tend to leave a lot of debris, such as chips and dust, on the top and bottom of the work piece. Further, due to the low compression cut, the cutting tools cause a lot of movement of the work piece which also results in a rougher cut and surface chips on the work piece. As can be seen, there is a need for a cutting tool that provides less movement and less chipping.

### BRIEF DESCRIPTION OF THE DRAWINGS

FIG. 1 is a plan view of a cutting tool.

FIG. 2 is a side plan view of a second alternate cutting tool with cutting angle indicated.

FIG. 3 is a side plan view of a third alternative cutting tool with cutting angle indicated.

FIG. 4 is a side plan view of a fourth alternative cutting tool with cutting angle indicated.

FIG. 5 is a side perspective view of a fifth alternative cutting tool.

FIG. 6 is a perspective view of the subject matter in FIG. 2.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cutting device comprising: a body made of a metal; an abrasive material attached to the body; and a cutting edge embedded in the abrasive material having an edge shear angle greater than about 50 degrees.

The present invention provides a high shear cutting tool providing a clean cut that enhances the stability of the work piece. The high shear cutting tool has a cutting angle that is greater than 50 degrees. The compression action of the high shear cutting angle pushes the cutting action into the work piece which provides a cleaner cut, better surface finish and less movement of the work piece. The present invention provides a user with the ability to achieve enhanced performance by using abrasion resistant material with the high shear angles.

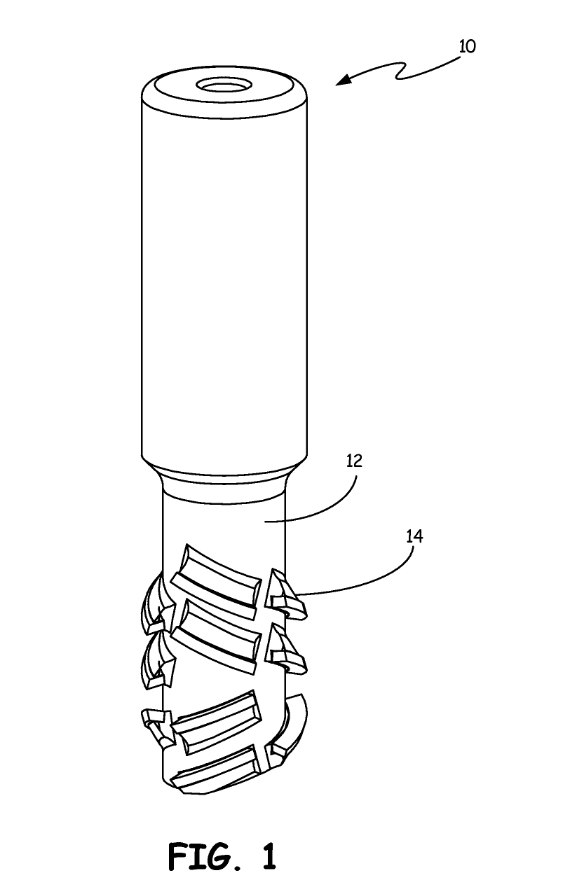

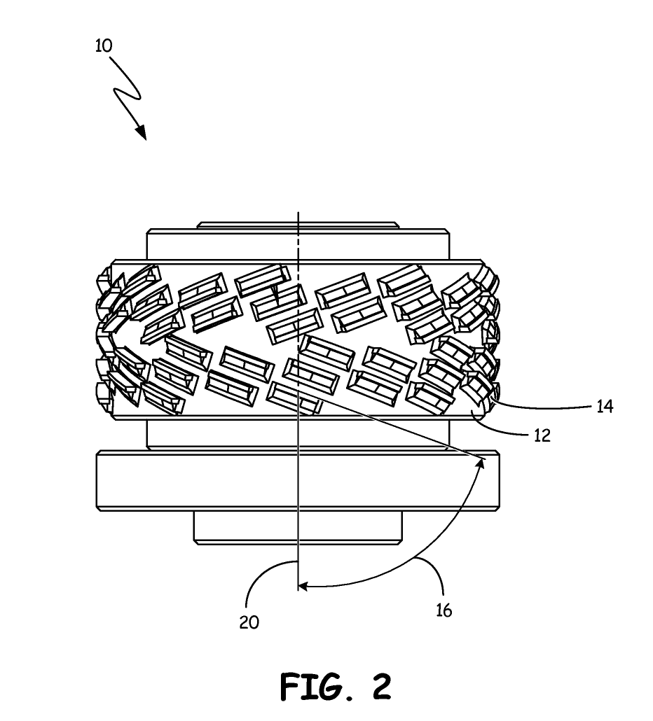

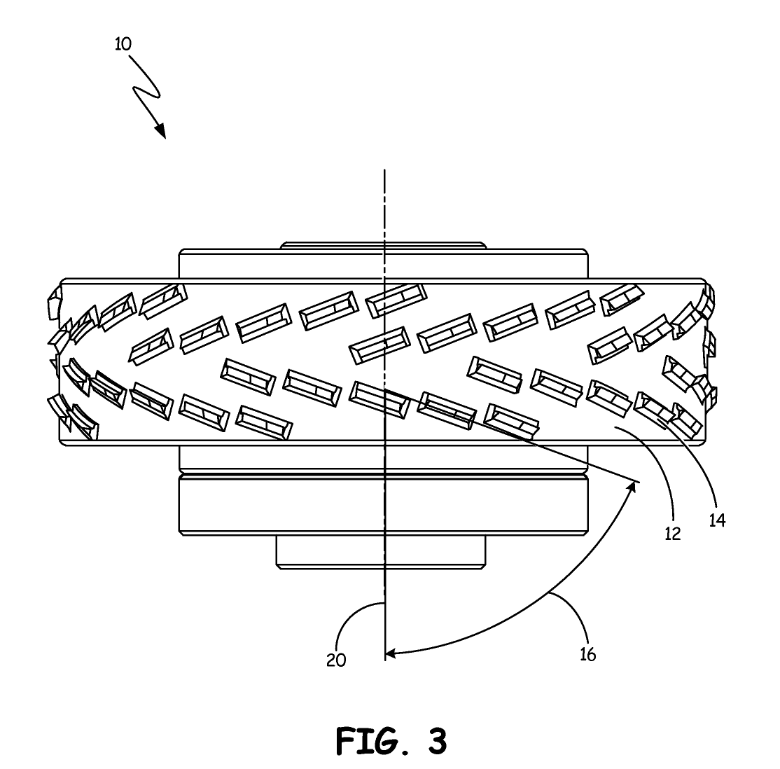

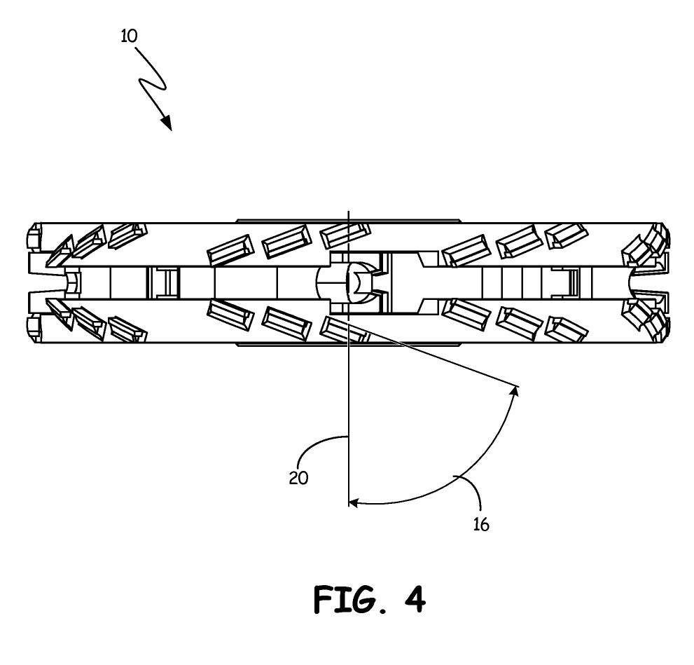

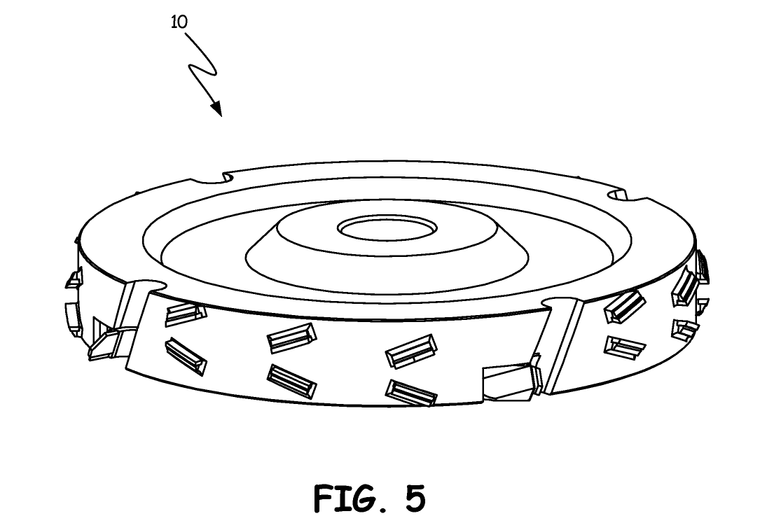

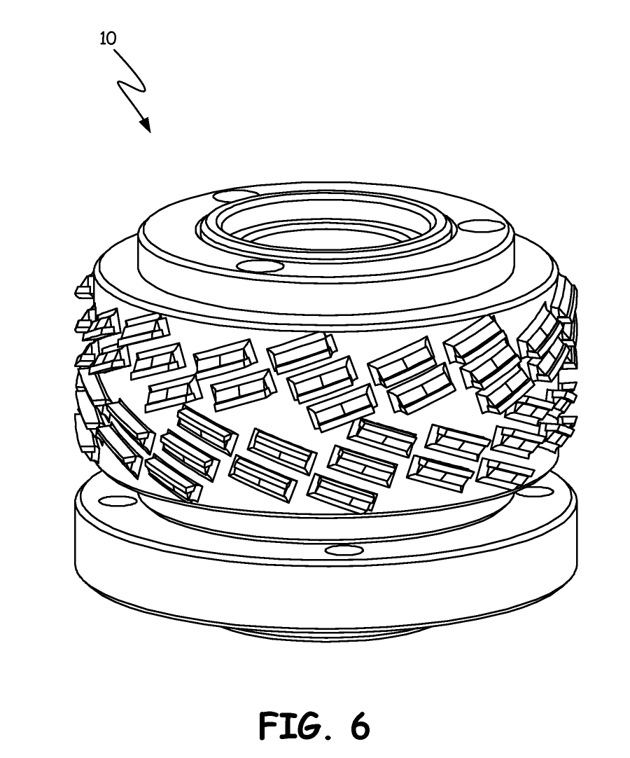

Referring now to FIGS. 1 through 6, the present invention may include a high shear cutting tool 10. The high shear cutting tool 10 may include a body 12, an abrasive material, such as teeth 14 and a cutting edge shear angle 16. The shear angle is an industry standard term measuring the angle of the teeth 14 relative to the vertical axis 20. The body 12 may be made of steel or any strong metal that may be used for cutting. The body 12 may provide a base for holding the abrasive material in place and provides a platform for maintaining the high shear cutting angles.

The abrasive material or teeth 14 may provide a wear resistant cutting edge. The abrasion resistant material 14 may be ground or electrical discharge machined (EDM) to provide the proper shear angles, which enables the tool to cut the work piece in a clean and chip free manner. The cutting edge shear angle 16 may be a cutting edge with a shear angle that is greater than about 50 degrees.

The proper shear angles may enable the tool to cut the work piece effectively. A variety of shear angles may be used to give different results. Further, in certain embodiments, different hook angles may also be incorporated which may enhance the performance and reduce the chipping on the top and bottom surfaces of the work piece

A method of making the device may include the following.

A person may first obtain a steel tool body which incorporates the proper high shear angles, then attach an abrasion resistant material or teeth, to the steel body, and then grind or EDM the proper shear angles to enable the tool to cut the work piece in a high compression mode (i.e. greater than 50 degrees). The invention may produce an end piece such as a straight or curved section made of wood, metal, plastic, or various other materials that has a smooth, clean cut, chip free surface and clean cuts on the top and bottom of the piece due to the effect of the high compression shear angles (greater than 50 degrees).

It should be understood, of course, that the foregoing relates to exemplary embodiments of the invention and that modifications may be made without departing from the spirit and scope of the invention as set forth in the following claims.

1. A cutting device comprising:
a cylindrical body having an outer peripheral surface and a central rotational axis;
a plurality of cutting teeth extending from said surface;
at least one of said teeth being oriented at a high shear angle relative to said axis of about 50 degrees or greater.

2. The cutting tool of claim 1 wherein said cutting teeth are all oriented at a high shear angle of 50 degrees or greater.

3. A method of clean cutting a work piece during rotary cutting by a cylindrical cutting tool having a central rotational axis and a plurality of cutting teeth thereon comprising the step of orienting the cutting teeth so that the shear angle as measured from the central axis is 50 degrees or greater.
